(19) United States
(12) Patent Application Publication
(10) Pub. No.: US 2013/0056896 A1
(43) Pub. Date: Mar. 7, 2013

(54) Compression Process for Producing a Bleach Containing Product

(71) Applicants: Claudia Schmaelzle, Ludwigshafen (DE); Kai Heppert, Ludwigshafen (DE); Jörg Pflug, Ludwigshafen (DE)

(72) Inventors: Claudia Schmaelzle, Ludwigshafen (DE); Kai Heppert, Ludwigshafen (DE); Jörg Pflug, Ludwigshafen (DE)

(21) Appl. No.: 13/583,422

(22) PCT Filed: Mar. 9, 2011
(86) PCT No.: PCT/GB2011/050462

§ 371 Date: Nov. 13, 2012

(30) Foreign Application Priority Data
Mar. 9, 2010 (GB) 1003892.5

(51) Int. Cl. C11D 3/395

(52) U.S. Cl. 264/115; 252/186.1; 510/218; 510/220

(57) ABSTRACT

A method for producing compressed tablets comprising bleach material, the method comprising the steps of;
1) forming a co-granulate comprising a bleach material and a water soluble binder,
2) adding the co-granulate from step 1, or a mixture comprising the co-granulate from step 1, to a mould cavity of a tablet-compressing machine,
3) applying a mean compression force to the co-granulate or the mixture in step 2 to form a compressed tablet and wherein the mean compression force used in step 3 is in the range of from 0.25 kN to 5 kN. The preferred bleach is PAP. The compressed tablets produced by the method exhibit good dissolution properties and good performance on bleachable stains.

### TECHNICAL FIELD

The present invention relates to a compaction process for producing a bleach-containing product. In particular it relates to a compaction process for producing such products wherein a relatively low compaction pressure is used to produce the bleach containing product. The product finds particular application in detergent applications such as in dishwashing.

### BACKGROUND AND PRIOR ART

It is well known in the detergent art to formulate bleaching products in a solid form, such as a compacted tablet, as this generally considered to be a convenient form for inclusion in many detergent compositions. It also provides a convenient form by which to handle hazardous bleach materials.

In order to obtain good cleaning performance on bleachable stains, e.g. tea, it is desirable to include a bleach material in detergent compositions which are to be used to remove such stains. In dishwashing, especially automatic dishwashing it is well recognised that performance on bleachable stains is one of the key attributes by which consumers assess the effectiveness of a detergent compositions.

However, many compacted tablets comprising bleach materials have been found to have dissolution characteristics which are slower than desired. This results in a slowly dissolving bleach tablet which in turn has the effect that the performance can be reduced as the contact time between the ingredients in the tablet and their substrate is limited by the slow dissolution characteristics.

Thus there is a need in the art to provide compacted tablets comprising a bleach material which exhibit good dissolution times and good performance on bleachable stains.

It is desirable to improve the dissolution time of the compacted tablet so that the bleach available in solution as quickly as possible to provide for a longer contact time between the bleach material and the bleachable stains thus providing the potential for improved removal of these stains.

This problem of improving the dissolution time of compressed tablets comprising bleach materials has been found to be especially acute for such tablets formulated with organic bleach materials such as organic peracid bleaches e.g. PAP. However, such types of bleach materials are effective at relatively low temperatures and are especially preferred for detergent applications on environmental and cost considerations as they can be used without the need for additional bleach catalysts or bleach activators.

It is an object of the present invention to address one or more of the above-mentioned problems.

In particular, it is an object of the present invention to provide compressed tablets comprising bleach materials which tablets exhibit good dissolution characteristics and bleachable stain removal properties.

### STATEMENT OF INVENTION

It has surprisingly been found that one or more of the above problems are addressed by the present invention.

Thus according to the present invention there is provided a method for producing compressed tablets comprising a bleach material, the method comprising the steps of
1) forming a co-granulate comprising a bleach material and a water soluble binder,
2) adding the co-granulate from step 1, or a mixture comprising the co-granulate from step 1, to a mould cavity of a tablet-compressing machine,
3) applying a mean compression force to the co-granulate or the mixture in step 2 to form a compressed tablet,
   wherein the mean compression force used in step 3 is in the range of from 0.25 kN to 5 kN.

It is preferred that the mean compression force used in step 3 is in the range of from 0.5 to 3 kN.

Preferably the compressed tablet has a hardness in the range of from 75N to 130N as determined by the method as described herein.

Especially good results have been obtained when the co-granulate comprises 30-90% by weight of the bleach material and 10-70% by weight of the water soluble binder based on the total weight of the co-granulate.

It is preferred that the bleach material comprises at least one inorganic peroxide, organic peracid or chlorine based bleach including derivatives and salts thereof or mixtures thereof, with organic peracid including derivatives and salts and mixtures thereof being most preferred. It is especially preferred that the at least one organic peracid comprises perbenzoic acid and/or at least one peroxycarboxylic acid. It is most preferred that the peroxycarboxylic acid comprises mono- or diperoxyphthalic acid, 2-octyldiperoxysuccinic acid, diperoxydodecanedicarboxylic acid, diperoxyazelaic acid, 6-phthalimidoperhexanoic acid (PAP) or imidoperoxycarboxylic acid or the derivatives and salts and mixtures thereof PAP is the most preferred bleach material according to the present invention.

It has been found to be especially advantageous for the water soluble binder to have a higher degree of water solubility at 20° C. than the bleach material. Organic binders are preferred and sugar based binders have been found to be effective. In particular the material known as ‘Isomalt’ which is a mixture of 6-O-a-D-Glucopyranosyl-D-sorbitol (1,6-GPS) and 1-O-a-D-Glucopyranosyl-D-mannitol dehydrate (1,1-GPM) has been found to be very effective as the water soluble binder and is especially preferred.

It is preferred that the compressed tablet comprises from 10-70% by weight of the bleach material and from 2-40% by weight of the water soluble binder.

An especially preferred optional ingredient according to the present invention is a disintegrant as it has been found that the combination of the water soluble binder with the disintegrant and the specified mean compression forces results in a compressed tablet having good dissolution and bleachable stain removal characteristics. The disintegrant may be present as part of the co-granulate or as part of the mixture in step 2 of the method. It is preferred that the disintegrant is an organic material, especially a saccharide based material such as a polysaccharide and most especially a soy polysaccharides.

It is preferred that the weight ratio of the bleach material to the water soluble binder is in the range of from 10:1 to 1:1. It is also that the weight ratio of the bleach material to the disintegrant, when present, is in the range of from 30:1 to 2:1.

According to a second aspect of the invention there is provided a compressed tablet comprising a bleach material and a water soluble binder produced by the method of the first aspect of the invention.

According to a third aspect of the invention there is provided a detergent composition comprising the compressed tablet of the invention. Preferably the composition is dishwashing composition and in particular an automatic dishwashing detergent composition.

According to a fourth aspect of the invention there is provided the use of the compressed tablet of the second aspect or of the detergent composition according to the third aspect in a washing operation, especially in an automatic dishwashing operation.

Surprisingly, it has been found that compressed tablets according to the present invention exhibit good dissolution characteristics and good performance on bleachable stains. It has also been found that by using organic peracid bleaches the compressed tablets these bleaches are rendered more suitable for coating than in their uncompressed state and this also increases the stability of the bleach as the coating provides an extra layer of protection for it.

Unless stated otherwise, all amounts herein are given as the percentage by weight of active ingredient based upon the weight of the total composition or the total particle as the context requires.

The term ‘mean compression force’ as used herein means the mean pressure applied to compress the co-granulate or mixture comprising the co-granulate in step 3 of the method of the invention to form the compressed tablet. If a force is applied by an upper and lower punch to carry out the compression step then this is the mean of these pressures.

The term ‘mould cavity’ as used herein means a cavity within the tablet compressing machine into which the material to be compressed is added and where the compression takes place.

The term ‘compressed tablet(s)’ as referred to herein means a tablet which has been produced by a compression step which results in the production of a dimensionally stable tablet. Typically this compression step is typically carried out on a particulate mixture to produce the tablet.

The term ‘at least partially encapsulated’ as used herein means that the water soluble or water dispersible packaging material at least partly surrounds the compressed tablet or other material being encapsulated.

The term ‘co-granulate’ as used herein includes any particle wherein the stated ingredients are held together in that particle. This includes particles produced by agglomeration, granulation, fluidized bed and spray-drying.

### DETAILED DESCRIPTION

The present invention will now be described in further detail.

i) Compressed Tablets

The compressed tablet may be of any desired shaped e.g. in the form of a tablet, pellet, rod, ball or lozenge. For the avoidance of doubt the term ‘tablet’ as used herein includes pills provided that they have been formed by a compression step.

Compression methods for the production of compressed tablets are applied industrially and are well known to the person skilled in the art and thus do not need to be described in detail here.

The mean compression force (kN) applied during the compression step of the method of the invention is in the range of from 0.25 kN to 5 kN, preferably from 0.5 to 3 kN, such as 0.75 to 3 kN. This is mean compression force combination with the presence of the water soluble binder, and when included the disintegrant, has been found to be very effective in providing good dissolution times for the compressed bleach material containing tablet which in turn aids the performance on bleachable stains.

The compressed tablet body preferably has a hardness of less than 150N (as measured on an Eweka Hardness testing apparatus TBH 220 using a pin of diameter 8 mm and length 14 mm, following the published method: “Direktmessung ohne Vorgabe” which is a measurement with constant speed of 0.5 mm/s) in order to keep the dissolution times as low as possible. Most preferably the hardness is in the range of from 75N to 130N, more preferably 85N to 120N.

It is preferred that the compressed tablet comprises from 10-70% by weight of the bleach material, preferably from 20-65% by weight such as from 30-60% by weight. It is especially preferred that the compressed tablet comprises from 2-40% by weight of the water soluble binder, preferably 5-35% by weight such as 10-30% by weight. It is preferred that the compressed tablet comprises from 10-70% by weight of the bleach material and from 2-40% by weight of the water soluble binder. When the disintegrant is used it is preferred that it is present in the compressed tablet in an amount of from 2-15% by weight, preferably from 3-10% by weight such as from 4-8% by weight.

According to one embodiment of the present invention the compressed tablet may be at least partially encapsulated with a coating and is preferably encapsulated with a coating to protect the bleach material.

Any suitable water soluble or water dispersible coating materials may be used and suitable examples are known in the art. It is preferred that a coating material is used and any suitable method may be used to apply the coating. Suitable coating materials include water soluble polymers (such as polyvinyl alcohol), non-ionic surfactants, anionic polyelectrolytes and cationic polyelectrolytes.

The coating is preferably applied in an amount of from 2% to 30% wt based on the total weight of the compressed tablet, more preferably of from 5% to 25%, most preferably of from 10 to 20% wt.

When the compressed bleach material-containing tablets comprise the water soluble binder and are produced at the mean compression force of the method of the present invention it has been found that especially good dissolution speeds and bleachable stain removal results can be obtained. Without wishing to be bound by theory it is believed that when the water soluble binder, and the disintegrant when included, are used with relatively low compaction pressures this leads to increased solubility for the compressed tablet as it is not so densely compacted and thus water is better able to ingress into the shaped body leading to faster dissolution times.

In addition to the co-granulate comprising the bleach material and the water soluble binder, the compressed tablet may comprise one or more of the optional ingredients as detailed below. When these optional ingredients are included they are typically added as mixture with the co-granulate prior to compression step 3 of the method of the invention so that the mixture comprising the co-granulate and the optional ingredients is compressed in step 3 of the method of the invention to produce the compressed tablet.

An especially preferred option ingredient to be mixed with the co-granulate is the disintegrant as described herein.

The compressed tablet of the invention may be used alone in a detergent application, e.g. as a detergent tablet or it may be used in combination with another part of a detergent composition e.g. a compressed tablet in combination with a liquid held inside an outer water soluble wrapper to produce a detergent composition. The compressed tablet may be held inside a water soluble or water dispersible wrapper as described below for the detergent composition and the comments therefor apply equally here. The compressed tablet may be used as a unit dose product as described herein below. The comments herein to the bleach material, the water soluble binder and the disintegrant apply equally to all aspects of the invention.

ii) Co-Granulate of Bleach Material and Binder

The co-granulate of the bleach material and the binder may be produced by any suitable co-granulation technique. Such techniques are well known in the art and do not require further description here but include agglomeration, granulation, fluidized bed and spray-drying. It is well within the ability of the person skilled in the art to be able to adjust the co-granulation technique parameters to produce the co-granulates.

The co-granulate may be in the form of a powder or granular material depending upon its particle size which is typically in the range of from 20 microns to 2000 microns (weight average mean size), more preferably 50 microns to 1500 microns, most preferably 100 microns to 900 microns, such as 200 microns to 800 microns.

It is especially preferred that the bleach material comprises from 30-90% by weight of the bleach material, preferably from 40-85% by weight such as from 50-80% by weight of total weight of the co-granulate. It is especially preferred that the water soluble binder comprises from 10-70% by weight of the total weight of the co-granulate, preferably 15-60% by weight such as 20-50% by weight. Especially good results have been obtained when the co-granulate comprises 30-90% by weight of the bleach material and 10-70% by weight of the water soluble binder based on the total weight of the co-granulate.

According to one embodiment of the invention the co-granulate further comprises a disintegrant in addition to the bleach material and the water soluble binder. In this embodiment any of the disintegrants herein may be included in the co-granulate. The amount of disintegrant in the co-granule in this embodiment is preferably in the range of from 2-15% by weight, preferably from 3-10% by weight such as from 4-8% by weight.

iii) Bleach Material

The bleach material used in the compressed tablets of the present invention may be selected from any conventional bleach material used in detergent compositions. The bleach material preferably comprises at least one inorganic peroxide or organic peracid or a chlorine based bleach including derivatives and salts thereof or mixtures thereof. Most preferred according to the invention are organic peracids and their derivatives/salts.

If at least one inorganic peroxide is used as the bleach material it preferably comprises a percarbonate, perborate and persulphate and/or hydrogen peroxide including derivatives and salts thereof and mixtures thereof. The sodium and potassium salts of these inorganic peroxides being most preferred, especially the sodium salts. Sodium percarbonate and sodium perborate are most preferred, especially sodium percarbonate.

It is especially preferred according to the present invention that the bleach material comprises at least one organic peracid including derivatives and salts and mixtures thereof. These bleach materials are effective at relatively low temperatures, typically around 30° C. and so do not require the use of a bleach activator or bleach catalyst to boost the bleaching performance. This makes these bleach materials especially preferred for detergent applications on environmental and cost considerations.

Organic peracids suitable according for use in the present invention include all organic peracids traditionally used as bleaches in detergent compositions. Preferred examples include perbenzoic acid and peroxycarboxylic acids especially mono- or diperoxyphthalic acid, 2-octyldiperoxysuccinic acid, diperoxydodecanedicarboxylic acid, diperoxy-azelaic acid, 6-phthalimidoperhexanoic acid (PAP) and imidoperoxy-carboxylic acid and the derivatives and salts and mixtures thereof. Especially preferred is 6-phthalimidoperhexanoic acid (PAP) and the derivatives and salts and mixtures thereof.

The bleach material may be used in a pure form but it is usually commercially available as a raw material which is a mixture of the bleach active material with carrier materials or other auxiliaries such as suitable compatible materials such as stabilisers for the bleach and fillers. Suitable stabilising materials include materials which are capable of taking up water, e.g. as water of crystallisation, such as sulphates.

iv) Water Soluble Binder

The compressed tablets of the present invention comprise a water soluble binder. The binder helps to improve the flow properties of the co-granulate in which it is also included and also acts as a binder to help produce the compressed tablet of the invention.

Without wishing to be bound by theory it is believed that the water soluble binder helps decrease the dissolution time of the compressed tablet.

Any suitable water binder may be used according to the present invention however it is especially preferred that the water soluble binder has a higher degree of water solubility at 20° C. than the bleach material used in the co-granulate/compressed tablet.

Organic binders are preferred according to the invention and sugar based binders have been found to be effective. In particular the material known as ‘Isomalt’ (available from BENEO-palatinit as Galen IQ™ 720, Galen IQ™ 721, Galen IQ™ 800 and Galen IQ™ 820) which is a mixture of 6-O-a-D-Glucopyranosyl-D-sorbitol (1,6-GPS) and 1-O-a-D-Glucopyranosyl-D-mannitol dehydrate (1,1-GPM) has been found to be very effective as the water soluble binder. It is available as mixtures of (1,6-GPS) to (1,1-GPM) in a weight ratio of 1:1 to 3:1.

By the term ‘water soluble’ as used herein is meant that at least 5 g of the binder dissolves in 100 g water at 20° C. (with agitation). Preferably at least 10 g of the binder dissolves in water at 20° C.

v) Disintegrant

An especially preferred optional ingredient according to the present invention is a disintegrant as it has been found that the combination of the water soluble binder with the disintegrant and the specified mean compression forces results in a compressed tablet having good dissolution and bleachable stain removal characteristics. Any suitable disintegrant can be included and it may be present in either the co-granulate and/or as an ingredient in the mixture comprising the co-granulate which is used to produced the compressed tablet. Thus the co-granulate or the mixture in step 2 of the method of the invention preferably comprises a disintegrant.

It is preferred that the disintegrant is an organic material and it is especially preferred that it comprises a saccharide based material such as a polysaccharide. Soy polysaccharides have been found to be very advantageous according the present invention and these are thus preferred types of disintergrants.

It is also possible to include cellulose based disintergrants in addition to, or as an alternative to, the saccharide based disintergrants.

One advantage of the present invention is that the incorporation of the specified binder and the disintegrant provides for improved dissolution times of the shaped bodies as it helps to break up the shaped body when used in the washing operation.

vi) Ratio of Bleach Material, Water Soluble Binder and Disintegrant

Generally the bleach material will be present in a greater percentage by weight than the water soluble binder, or when present, the disintegrant (based on active ingredient) in either the co-granulate or in the compressed tablet.

It is preferred that the weight ratio of the active amount of the bleach material to the water soluble binder according to the invention is in the range of from 10:1 to 1:1, more preferably 7:1 to 1.25:1 and especially 5:1 to 1.5:1.

The disintegrant is an especially preferred optional ingredient according to the present invention and when included it is preferred that it is present in a lesser percentage by weight than either the bleach material or the water soluble binder.

It is preferred that the weight ratio of the active amount of the bleach material to the disintegrant is in the range of from 30:1 to 2:1, more preferably 20:1 to 5:1 and especially 15:1 to 7.5:1. It is preferred that the weight ratio of the water soluble binder to the disintegrant is in the range of from 10:1 to 1.5:1, more preferably 7:1 to 2:1 and especially 5:1 to 2.5:1.

It is preferred according to the present invention that the bleach material comprises an organic peracid, the water soluble binder comprises sugar based binder and the disintegrant comprises a polysaccharide. It is especially preferred that the bleach material comprises PAP, the water soluble binder comprises a mixture of 6-O-a-D-Glucopyranosyl-D-sorbitol (1,6-GPS) and 1-O-a-D-Glucopyranosyl-D-mannitol dehydrate (1,1-GPM) and the disintegrant comprises a soy polysaccharide. It is preferred that these ingredients are used together in the ratios given herein.

vii) Detergent Compositions

The detergent compositions and the compressed tablets of the invention may be used in principle for any cleaning operation. However, it is preferred that they are laundry detergents or hard surface cleaning compositions for example dishwashing detergents, floor cleaners or surface cleaners. It is most preferred that the hard surface cleaning compositions are dishwashing compositions and in particular automatic dishwashing compositions.

The detergent composition of the third aspect of the invention may be in any suitable physical form provided that it comprises the compressed tablet of the present invention. The detergent compositions may be produced by any suitable method.

The detergent compositions and/or the compressed tablet may be formulated as a unit dose detergent composition i.e. designed to be used as a single portion of detergent composition in a single washing operation. Of course, one or more of such single portions may be used in a cleaning operation if desired.

If the compressed tablet or detergent formulation is intended as a unit dose product it may comprise a water soluble or water dispersible package of water soluble or water dispersible packaging material with the composition/shaped body being at least partly enveloped by the packaging material. It is preferred that the composition/shaped body is fully enveloped by the water soluble or water dispersible packaging material. Such packages are well known in the art, see for example and may be of any suitable form and shape including that of a pre-formed container, preferably a self-supporting container see for example WO 09/034355 and WO 01/36290. The package may be formed by any suitable method, for example the method described in WO 2004/081161 which method is incorporated by reference herein. Any suitable conventional method may be used to form the water soluble or water dispersible package, e.g. thermoforming and/or vacuum forming or injection moulding although the latter is less preferred.

Typically the detergent composition comprises the compressed tablet of the present invention in an amount by weight of from 1% to 60% wt, preferably from 5% to 50% wt such as from 10% to 45% wt based on the total weight of the detergent composition.

viii) Optional Ingredients

The compressed tablet and the detergent composition comprising the compressed tablet may comprise one or more of the optional ingredients in conventional amounts as detailed below. All amounts for the optional ingredients are referred to as the amount of the optional ingredient based on the total weight of the compressed tablet or detergent composition as appropriate.

It is possible to include bleach sensitive material in the compressed tablet or detergent compositions although these will typically be protected from the bleach material in some way. This may be achieved by them being placed in a different part of the compressed tablet/composition or by either the bleach material or the bleach sensitive material being encapsulated to prevent interaction between these incompatible ingredients.

Bleach sensitive ingredients include enzymes and any type of enzyme typically used in detergent compositions may be used. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired.

The bleach sensitive ingredient may also comprise a perfume or dye. Any type of perfume or dye may be used.

The bleach sensitive material may preferably comprise one or more bleach activators or bleach catalysts depending upon the nature of the bleaching compound. Any suitable bleach activator may be included for example TAED if this is desired for the activation of the bleach material. Any suitable bleach catalyst may be used for example manganese acetate or dinuclear manganese complexes such as those described in EP-A-1,741,774. The organic peracids such as perbenzoic acid and peroxycarboxylic acids e.g. PAP do not require the use of a bleach activator or catalyst as these bleaches are active at relatively low temperatures such as about 30° C. and this contributes to such bleach materials being especially preferred according to the present invention.

Surfactant may also be included in the compressed tablet or detergent composition and any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

Non-ionic surfactants are especially preferred according to the present invention, especially for automatic dishwashing compositions. For laundry and cleaning applications (excluding automatic dishwashing) other surfactants such as anionic surfactants are preferably included and suitable types are well known in the art.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]ₓ[CH₂CH₂O]_{y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOH²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the shaped body or the detergent composition in an amount of from 0.1% wt to 20% wt, more preferably 1% wt to 15% wt, such as 2 to 10% wt based on the total weight of the compressed tablet or detergent composition.

A builder may also be included and it may be either a phosphorous-containing builder or a phosphorous-free builder as desired.

If phosphorous-containing builders are also to be used it is preferred that mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15% wt to 60% wt, such as 20 or 25% wt to 40 or 50% wt.

If a phosphorous-free builder is included it is preferably chosen from amino acid based compounds and/or succinate based compounds. The terms ‘succinate based compound’ and ‘succinic acid based compound’ are used interchangeably herein. Conventional amounts of the amino acid based compound and/or succinate based compound may be used typically in the range of from 20% wt to 80% wt, such as 25 or 30% wt to 60 or 70% wt.

Preferred examples of amino acid based compounds which may be used are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

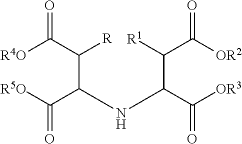

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts. It is especially preferred according to the present invention that the builder comprises methyl-glycine-diacetic acid, glutamic-N,N-diacetic acid, tetrasodium imminosuccinate, or (hydroxy)iminodisuccinic acid and salts or derivatives thereof.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present is an amount of at least 20 wt %, and most preferably at least 25 wt %, preferably in an amount of up to 70 wt %, preferably up to 65 wt %, more preferably up to 60 wt %. The actual amount used in the compressed tablets of detergent compositions will depend upon the nature of the builder used. If desired a combination of phosphorous-containing and phosphorous-free builders may be used.

The compressed tablets and detergent compositions may optionally further comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present is an amount of up to 10 wt %, preferably at least 5 wt %. The actual amount used in the compressed tablet and detergent compositions will depend upon the nature of the builder used.

The compressed tablet or detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The compressed tablet and detergent compositions may comprise one or more anti-corrosion agents, especially when they compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Zinc acetate, zinc sulphate and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

Any conventional amount of the anti-corrosion agents may be included. However, it is preferred that they are present in an total amount of from 0.01% wt to 5% wt, preferably 0.05% wt to 3% wt, more preferably 0.1 to 2.5% wt, such as 0.2% wt to 2% wt based on the total weight.

Polymers intended to improve the cleaning performance of the compressed tablet or detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinyl-methyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

The compressed tablets and detergent composition may also comprise one or more foam control agents. Suitable foam control agents for this purpose are all those conventionally used in this field, such as, for example, silicones and their derivatives and paraffin oil. The foam control agents are preferably present in amounts of 0.5% by weight or less.

The compressed tablets and detergent compositions may also comprise minor, conventional, amounts of preservatives.

The invention is further described with reference to the following non-limiting Examples. Further examples within the scope of the invention will be apparent to the person skilled in the art.

### EXAMPLE

### Examples 1, 2 and 3

Three different types of particles were prepared comprising;

1) 6-phthalimidoperoxyhexanoic acid (PAP) as the bleach material available as Eureco™ WM1 from Solvay Chemicals and comprising 70-75% wt active PAP.

2) a mixture of 6-O-a-D-Glucopyranosyl-D-sorbitol (1,6-GPS) and 1-0-A-d-Glucopyranosyl-D-mannitol dehydrate (1,1-GPM) as the binder material known as ‘Isomalt’ and available from BENEO-Palatinit. Either GalenlQ™ 800 or GalenlQ™ 720 are used in these examples, and

3) a soy polysaccharide as the disintegrant available as Emcosoy STS IP from J. Rettenmaier & Sohne GmbH.

Examples 1, 2 and 3 were prepared by firstly co-granulating the bleach material and the binder material together to form a co-granulate of these two materials and then post-adding thereto the disintegrant to produce a particulate mixture having the overall formulation as shown in Table 1 below. All percentages are by weight based on the amount of raw material used (not active weight for the PAP) and the total weight of the resultant particulate mixture.

TABLE 1

| | Ex 1 | Ex 2 | Ex 3 |
|---|---|---|---|
| Raw materials | % wt | % wt | % wt |
| 6-phthalimido- | 65.0 | 65.0 | 75.0 |
| peroxyhexanoic acid | | | |
| (PAP); Eureco ™ | | | |
| WM1 | | | |
| Isomalt GalenlQ ™ | 30.0 | | 20.0 |
| 800 | | | |
| Isomalt GalenlQ ™ | | 30.0 | |
| 720 | | | |
| Emcosoy STS IP | 5.0 | 5.0 | 5.0 |

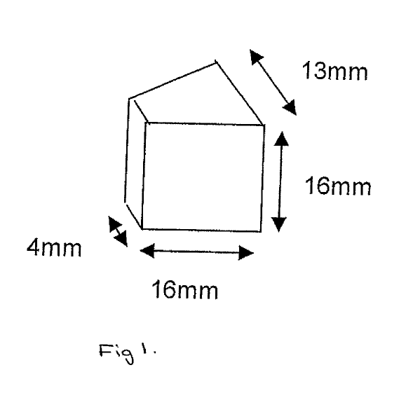

The resultant particulate mixtures were formed into flat topped wedge shaped tablets being of a six sided parallelepiped configuration. The apex of the wedge is rectangular with dimensions of 4 mm×16 mm, the back face is a square of 16 mm×16 mm, the base is rectangular with dimensions of 13 mm×16 mm and the remaining three sides extend from the apex down to the base (as shown in FIG. 1) and having a weight of approximately 2 g. The tablets for each example were produced in a Kilian SP 300 tablet press. The compression force of the upper and lower punches (in mean kN) used for each example and the mean compression force (kN) is given in table 2 alone with the average hardness (N) of the tablets of each example. The hardness of the tablets was measured according to the method described in the description.

TABLE 2

| Raw materials | Ex 1 | Ex 2 | Ex 3 |
|---|---|---|---|
| Compression force of | 1.6 | 1.3 | 1.9 |
| upper punch (kN) | | | |
| mean | | | |
| Compression force of | 1.4 | 1.1 | 1.5 |
| lower punch (kN) | | | |
| mean | | | |
| Compression force | 1.5 | 1.2 | 1.7 |
| (kN) mean | | | |
| Hardness (N) mean | 108 | 92 | 113 |

The tablets produced as above were stored at 40° C. and 75% relative humidity in glass bottles with the lid left open to the atmosphere and the time taken for the tablets to dissolve in the Erweka 40° C. disintegration test was measured on a Erweka ZT 504 machine at 40° C. using 30 strokes/min; height of stroke of 55 mm. The results are given in Table 3 (mean values in minutes and seconds).

TABLE 3

| Disintegration times | Ex 1 | Ex 2 | Ex 3 |
|---|---|---|---|
| 0 weeks | 4.00 | 2.00 | 4.30 |
| 3 weeks | 2.55 | 1.55 | 3.35 |
| 6 weeks | 2.25 | 2.10 | 4.00 |
| 9 weeks | 3.30 | 2.30 | 4.05 |

1. A method for producing compressed tablets comprising a bleach material, the method comprising the steps of;
1) forming a co-granulate comprising a bleach material and a water soluble binder,
2) adding the co-granulate from step 1, or a mixture comprising the co-granulate from step 1, to a mould cavity of a tablet-compressing machine,
3) applying a mean compression force to the co-granulate or the mixture in step 2 to form a compressed tablet,
wherein the mean compression force used in step 3 is in the range of from 0.25 kN to 5 kN.

2. A method according to claim 1, wherein the mean compression force used in step 3 is in the range of from 0.5 to 3 kN.

3. A method according to claim 1, wherein the compressed tablet has a hardness in the range of from 75N to 130N.

4. A method according to claim 1, wherein the co-granulate comprises 30-90% by weight of the bleach material and 10-70% by weight of the water soluble binder based on the total weight of the co-granulate.

5. A method according to claim 1, wherein the bleach material comprises at least one inorganic peroxide, organic peracid or chlorine based bleach including derivatives and salts thereof or mixtures thereof.

6. A method according to claim 5, wherein the bleach material comprises at least one organic peracid.

7. A method according to claim 5 wherein the at least one organic peracid comprises perbenzoic acid and/or at least one peroxycarboxylic acid.

8. A method according to claim 7, wherein the at least one peroxycarboxylic acid comprises mono- or diperoxyphthalic acid, 2-octyldiperoxysuccinic acid, diperoxydodecanedicarboxylic acid, diperoxy-azelaic acid, 6-phthalimidoperhexanoic acid or imidoperoxycarboxylic acid or the derivatives and salts and mixtures thereof.

9. A method according to claim 7, wherein the at least one peroxycarboxylic acid comprises 6-phthalimidoperhexanoic acid and derivatives and salts and mixtures thereof.

10. A method according to claim 1, wherein the water soluble binder has a higher degree of water solubility at 20° C. than the bleach material.

11. A method according to claim 10 wherein the water soluble binder is an organic binder.

12. A method according to claim 11, wherein the organic binder is a sugar based binder.

13. A method according to claim 12, wherein the sugar based binder comprises a mixture of 6-O-a-D-Glucopyranosyl-D-sorbitol (1,6-GPS) and 1-O-a-D-Glucopyranosyl-D-mannitol dehydrate (1,1-GPM).

14. A method according to claim 1, wherein the compressed tablet comprises from 10-70% by weight of the bleach material and from 2-40% by weight of the water soluble binder.

15. A method according to claim 1, wherein the co-granulate or the mixture in step 2 comprises a disintegrant.

16. A method according to claim 15, wherein the disintegrant comprises an organic material.

17. A method according to claim 16, wherein the organic material comprises is a saccharide based material.

18. A method according to claim 17, wherein the saccharide based material comprises a polysaccharide.

19. A method according to claim 18, wherein the saccharide based material comprises a soy polysaccharide.

20. A method according to claim 1, wherein the weight ratio of bleach material to the water soluble binder is in the range of from 10:1 to 1:1.

21. A method according to claim 15, wherein the weight ratio of the bleach material to the disintegrant is in the range of from 30:1 to 2:1.

22. A compressed tablet comprising a bleach material and a water soluble binder produced by the method according to claim 1.

23. A detergent composition comprising the compressed tablet according to claim 22.

24. A detergent composition according to claim 23, wherein the composition is a dishwashing composition.

25. A detergent composition according to claim 24, wherein the dishwashing composition is an automatic dishwashing composition.

26. A washing operation that uses a compressed tablet according to claim 22.

27. A washing operation according to claim 26 which is an automatic dishwashing operation.
